(19) United States
(12) Patent Application Publication
(10) Pub. No.: US 2003/0192430 A1
(43) Pub. Date: Oct. 16, 2003

(54) Helical built-in purifier for gas supply cylinders

(76) Inventors: Ronald Martin Pearlstein, Macungie, PA (US); Lawrnce Paul Jarrett, Wind Gap, PA (US); Neil Alexander Downie, Guildford (GB)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 10/120,708

(22) Filed: Apr. 11, 2002

(51) Int. Cl. B01D 53/02

(52) U.S. Cl. 95/90; 96/108

(57) ABSTRACT

A fluid storage and purification system which comprises a cylindrical vessel having an exterior and an interior containing a fluid, the vessel having a first end and a second end, wherein the first end has a cylindrical neck, and wherein the inside diameter of the cylindrical neck is smaller than the inside diameter of the vessel; a helical purifier tube assembly which is disposed in the interior of the vessel, wherein the maximum outer diameter of the helical purifier tube assembly is larger than the inside diameter of the cylindrical neck, wherein the tube has a first end and a second end, and wherein the first end is in fluid flow communication with the interior of the vessel; and a valve comprising a body, an inlet, and an outlet. The valve body can be sealably connected to and disconnected from the cylindrical neck and the second end of the helical purifier tube assembly can be connected to the inlet of the valve. One or more materials are disposed inside the helical purifier tube assembly, which materials are capable of selectively removing impurities from the fluid. The fluid in the interior of the vessel can be withdrawn through the helical purifier tube assembly and delivered through the outlet of the valve to the exterior of the vessel.

### BACKGROUND OF THE INVENTION

Industrial gases which are utilized in small to moderate volumes are stored at ambient temperature in pressurized cylinders from which gas is withdrawn as needed. Gases which have critical temperatures below ambient temperature are stored at high pressures determined by the design pressure ratings of the cylinders. Examples of these include low-boiling gases such as nitrogen, oxygen, hydrogen, helium, and methane, which are withdrawn from the storage cylinders without phase change. Gases which have critical temperatures above ambient temperature are stored in cylinders as saturated liquids at their respective vapor pressures, and these liquids vaporize as saturated vapor which is withdrawn from the cylinders. Common examples of such liquefied compressed gases are chlorine, ammonia, and light hydrocarbons such as propane and butane.

There is a need in certain industries for very high purity gases supplied by cylinders as described above. For example, very high purity gases are utilized in the electronics industry for manufacturing semiconductor and optoelectronic devices, video display panels, fiber optic devices, and micro-electromechanical systems. Examples of such gases include hydrogen chloride, hydrogen bromide, hydrogen fluoride, chlorine, ammonia, tungsten hexafluoride, disilane, dichlorosilane, trimethylsilane, and boron trichloride.

The demand for higher purity levels of these gases, especially those supplied as liquefied compressed gases, is growing and there is a trend towards processes which consume these gases at higher flow rates. This trend toward higher usage rates is driven in part by the larger size of the substrate materials used in the manufacturing processes mentioned above. These higher flow rates, in turn, have generated a demand for larger sizes of transportable cylinders used to deliver these high purity gases. Such larger cylinders can provide these higher flow rates while reducing the frequency of cylinder return to the gas suppliers for refilling.

High purity gases can be provided by passing a product of lower purity through a bed filled with purification material comprising adsorbent, catalyst, filtration, and/or getter materials. In one method, the product is purified during the cylinder filling process, which is generally described as point-of-fill (POF) purification. Alternatively, product gas can be purified by a system installed at the consumer's site, which is generally described as a point-of-use (POU) purifier. Both of these purification approaches have disadvantages. In order to achieve acceptably short fill times, the POF purifier must be relatively large to accommodate the high flow rates of the filling process. Some products are introduced into the transportable cylinders as liquids, so the purification medium for a POF purifier must remain stable when contacted with liquid product. Also, the higher viscosity and the lower diffusivity of the liquid phase requires even larger and more expensive purifiers in order to achieve product purity at acceptable flow rates. In addition, a POF purifier cannot remove impurities that are introduced into the product by the transportable cylinder itself. Examples of undesired impurities that are most frequently introduced by cylinder filling and transportation include water, air, particles and metallic compounds.

The POU purifier overcomes some of the limitations of POF purification, but it also has some distinct disadvantages. The purification material in a POU purifier eventually will become spent and allow impurities into the high purity product gas. When this occurs in an electronic device fabrication plant, for example, it can result in defective devices and associated scrap or can completely interrupt the fabrication process. Furthermore, the impurities that break through a spent POU purifier may contaminate downstream equipment, thus requiring expensive downtime for cleaning or replacement of components. Breakthrough of a POU purifier is unpredictable since the purity of the gas entering the purifier typically is unknown and may be variable.

A third type of purification method, built-in-purification (BIP), can overcome the limitations of POU and POF systems in these applications. In the BIP process, the purification material is placed in an internal vessel or tube which is installed inside of the storage cylinder. The product gas is purified during withdrawal from the cylinder, thereby removing impurities originally present in the product as well as impurities introduced by the cylinder filling and transportation steps. Versions of the BIP process have been described, for example, in representative U.S. Pat. Nos. 5,409,526 and 5,980,599.

The quantity of purification material required in the internal purifier vessel in a larger-sized product cylinder (for example greater than 50 liters) will be proportionally greater than that typically used in smaller cylinders. The use of a larger internal purifier vessel or tube will require a different design than those utilized in the prior art represented by U.S. Pat. Nos. 5,409,526 and 5,980,599 cited above. For example, it may be desirable to orient a larger product cylinder horizontally, with the connections for product removal located in one end of the cylinder. In this case, the larger internal purifier vessel within the cylinder would be oriented horizontally and may create significant bending stress on the piping or tubing which connects the purifier vessel to the cylinder discharge assembly. In addition, regardless of cylinder orientation, a higher product gas withdrawal rate may require a greater media depth to maintain satisfactory product purity and media capacity. This media depth may require an internal purifier vessel which is longer than the internal length of the cylinder.

Thus there is a need for new designs of internal purifier systems used in larger gas storage cylinders to provide very high purity product gas at higher delivery rates to end consumers such as electronic component fabricators. The invention described below and defined by the claims which follow addresses the need for advanced internal purifier systems for larger cylinders used for gas storage and transportation.

### BRIEF SUMMARY OF THE INVENTION

The invention relates to a fluid storage and purification system which comprises:

(a) a cylindrical vessel having an exterior and an interior containing a fluid, the vessel having a first end and a second end, wherein the first end has a cylindrical neck, and wherein the inside diameter of the cylindrical neck is smaller than the inside diameter of the vessel;

(b) a helical purifier tube assembly which is disposed in the interior of the vessel, wherein the maximum outer diameter of the helical purifier tube assembly is larger than the inside diameter of the cylindrical neck, wherein the tube has a first end and a second end, and wherein the first end is in fluid flow communication with the interior of the vessel;

(c) one or more materials disposed inside the helical purifier tube assembly, which materials are capable of selectively removing impurities from the fluid; and

(d) a valve comprising a body, an inlet, and an outlet, wherein the valve body can be sealably connected to and disconnected from the cylindrical neck and wherein the second end of the helical purifier tube assembly is connected to the inlet of the valve, whereby the fluid in the interior of the vessel can be withdrawn through the helical purifier tube assembly and delivered through the outlet of the valve to the exterior of the vessel.

The one or more materials disposed inside the helical purifier tube assembly may be granular materials and may be selected from the group consisting of adsorbent materials, absorbent materials, catalytic materials, getter materials, and filtration materials, wherein the materials are capable of selectively removing impurities from the fluid. The fluid may be a gas. Alternatively, the fluid may comprise coexisting liquid and vapor phases wherein the helical purifier tube assembly is oriented in the cylinder such that vapor can be withdrawn through the tube. The cylinder may be oriented vertically or alternatively may be oriented horizontally.

When oriented horizontally, the cylinder may have an additional cylindrical neck disposed at the second end, and may further comprise another valve comprising a body, an inlet, and an outlet, wherein the valve body can be sealably connected to and disconnected from the additional cylindrical neck.

The invention also relates to a method of supplying a purified fluid product which comprises:

(a) providing a cylindrical vessel having an exterior and an interior, wherein the vessel is closed at one end and fitted with a cylindrical neck at the other end, wherein the inside diameter of the cylindrical neck is smaller than the inside diameter of the vessel, and wherein fluid containing one or more impurities is disposed in the interior of the vessel;

(b) providing a helical purifier tube assembly which is disposed in the interior of the vessel, wherein the maximum outer diameter of the helical purifier tube assembly is larger than the inside diameter of the cylindrical neck, wherein the helical purifier tube assembly has a first end and a second end, and wherein the first end is in fluid flow communication with the interior of the vessel;

(c) providing one or more granular materials disposed inside the helical purifier tube assembly and selected from the group consisting of adsorbent materials, absorbent materials, catalytic materials, getter materials, and filtration materials, wherein the materials are capable of selectively removing impurities from the fluid;

(d) providing a valve comprising a body, an inlet, and an outlet, wherein the valve body can be sealably connected to and disconnected from the cylindrical neck, and wherein the second end of the helical purifier tube assembly is connected to the inlet of the valve, whereby the fluid in the interior of the vessel can be withdrawn through the helical purifier tube assembly and delivered through the outlet of the valve to the exterior of the vessel; and

(e) withdrawing fluid from the interior of the vessel through the helical purifier tube assembly, contacting the fluid with the one or more granular materials disposed therein to yield a purified fluid product, and withdrawing the purified fluid product through the valve to the exterior of the vessel.

The fluid may be a gas. Alternatively, the fluid may comprise coexisting liquid and vapor phases and the helical purifier tube assembly may be oriented in the cylinder such that vapor can be withdrawn through the tube. The cylinder may be oriented vertically or alternatively may be oriented horizontally.

The invention also relates to a method of making a fluid storage and purification system which comprises:

(a) providing a cylindrical vessel having an exterior and an interior, the vessel having a first end and a second end, wherein the first end has a cylindrical neck, and wherein the inside diameter of the cylindrical neck is smaller than the inside diameter of the vessel;

(b) providing a helical purifier tube assembly, wherein the maximum outer diameter of the helical purifier tube assembly is larger than the inside diameter of the cylindrical neck, wherein the helical purifier tube assembly has a first end and a second end, and filling at least a portion of the helical purifier tube assembly with one or more materials selected from the group consisting of adsorbent materials, absorbent materials, catalytic materials, getter materials, and filtration materials, wherein the materials are capable of selectively removing impurities from the fluid;

(c) providing a valve comprising a body, an inlet, and an outlet, wherein the valve body can be sealably connected to and disconnected from the cylindrical neck, and sealably connecting the second end of the helical purifier tube assembly to the inlet of the valve to provide a valve and tubing assembly;

(d) inserting the first end of the helical purifier tube assembly into the cylindrical neck, rotating the valve and tubing assembly while inserting the helical purifier tube assembly through the neck and into the interior of the vessel; and

(e) sealably connecting the valve to the cylindrical neck.

The invention further relates to a fluid flow control and fluid purification assembly which comprises:

(a) a helical purifier tube assembly having a first end and a second end, wherein the first end is in flow communication with a fluid;

(b) one or more purification materials disposed inside the helical purifier tube assembly, which materials are capable of selectively removing impurities from the fluid; and

(c) a valve comprising a body, an inlet, and an outlet, wherein the second end of the helical purifier tube assembly is sealably connected to the inlet of the valve, whereby the fluid can be withdrawn through the helical purifier tube assembly and delivered through the outlet of the valve.

The one or more materials disposed inside the helical purifier tube assembly may be granular materials selected from the group consisting of adsorbent materials, absorbent materials, catalytic materials, getter materials, and filtration materials.

### BRIEF DESCRIPTION OF SEVERAL VIEWS OF THE DRAWINGS

FIG. 1 shows an embodiment of the present invention having a helical purifier tube assembly disposed in a portion of the interior length of a single-ended fluid cylinder.

FIG. 2 is an enlarged view of a section of FIG. 1.

FIG. 3 shows another embodiment of the invention having a helical purifier tube assembly disposed in the entire interior length of a single-ended fluid cylinder.

FIG. 4 shows yet another embodiment of the invention in which a double helical purifier tube assembly is disposed in the entire interior length of a single-ended fluid cylinder.

FIG. 5 is an illustration of an embodiment of the invention adapted to horizontal placement of a fluid cylinder.

FIG. 6 is an illustration of an alternative embodiment of the invention adapted to horizontal placement of a fluid cylinder.

### DETAILED DESCRIPTION OF THE INVENTION

High purity gases can be supplied to end users from pressurized cylinders containing a single gas phase or coexisting liquid and vapor phases. In the first of these supply modes, the gas pressure in the cylinder drops as gas is withdrawn, and gas pressure to the consumer is controlled by a pressure regulator. In the second of these supply modes, a compressed liquefied gas is stored in the cylinder and vapor is withdrawn therefrom while the liquid vaporizes; the cylinder pressure is the existing vapor pressure. Gas pressure to the consumer is controlled at a pressure below the vapor pressure by a pressure regulator.

Undesirable impurities may be present in the fluid stored in the cylinder and these impurities can be removed readily by means of a built-in purifier located inside of the cylinder. These impurities may include undesirable soluble compounds such as water, carbon dioxide, hydrocarbons, metal salts, and oxygen, and also may include insoluble particulate material. The purifier may be a cylindrical vessel or tube which contains one or more materials selected from adsorbents, catalysts, and getters which are capable of removing the soluble impurities to very low concentration levels, typically down to levels of parts per billion by volume (ppbv). The purifier also may include a filter to remove particulate material. In prior art applications of built-in purifiers, the purifier assembly typically is attached to the cylinder valve inlet port and is designed to fit through the cylinder neck.

The purifier assembly initially is charged with the purification materials, attached to the inlet of the valve, the purifier assembly is inserted through the cylinder neck, and the valve (which has a threaded inlet section) is screwed into the threads in the cylinder neck to seal the purifier into the cylinder. The cylinder is filled with the product fluid (gas or liquid). Gas then is withdrawn through the purifier, impurities are removed therein, and a high-purity gas product is withdrawn through the valve to the consumer. When the purification materials become spent after a period of operation, the valve is unscrewed from the cylinder, the spent purification materials are replaced or regenerated, and the purifier and valve are reinstalled in the cylinder.

When the consumer of the high purity gas product supplied by the built-in purifier requires higher gas supply rates, the built-in purifier tube must be enlarged. Since the diameter of the purifier tube is fixed by the diameter of the cylinder inlet neck, the purifier tube must be lengthened to give acceptable product purity and purifier operating life. This lengthening may raise potential problems or limitations in the design of the purifier assembly. One problem is that the required purifier length may be longer than the internal length of the cylinder. A second problem arises when the cylinder is oriented horizontally, which is the typical orientation of larger, longer cylinders. As the purifier tube becomes longer and heavier, increased torque is applied at the point of attachment of the purifier to the valve inlet because the distance between the attachment point and the center of mass of the internal purifier tube increases. Because of the weight of the purifier tube, the force exerted by the cantilevered purifier assembly may exceed the strength of the materials of construction at the connection point. Since the achievable purity and capacity of the straight purifier tube increases with increasing length, the limitations imposed either by the dimensions of the tube or by the strength of the connection between the cantilevered purifier tube and the cylinder valve can limit the performance of the built-in purifier. This would limit the purity of the gas product delivered to the consumer.

The present invention addresses these problems by configuring the purifier tube in a generally helical shape to form a helical purifier tube assembly, which provides a longer effective length than a straight tube of the same actual length. This allows the use of a larger amount of purification material and also gives a greater length to diameter ratio compared to a straight tube. The maximum outer diameter of the helical purifier tube assembly is larger than the inside diameter of the cylinder neck and can approach the inside diameter of the cylinder. As explained below, the pitch and diameter of the helical purifier tube assembly are selected such that the assembly can be inserted into the cylinder by rotating the helical tube assembly as it passes through the cylinder neck. The term “helical purifier tube assembly” as used herein means a length of tubing or pipe wherein at least a portion of the length of tubing or pipe is coiled or formed into a generally helical shape.

A helix is defined geometrically as a three-dimensional curve characterized by three parameters—the pitch, which is the distance between adjacent loops measured parallel to the axis of the helix; the radius or diameter measured perpendicular to the axis, and the helix angle which is the angle between a line tangent to the helix and a plane perpendicular to the axis of the helix. The axis of the tubing which forms the helical purifier tube assembly defines the pitch and angle of the generally helical shape of the helical purifier tube assembly.

The helical purifier tube assembly is characterized further by the diameter of the tubing and the maximum outer diameter of the helical purifier tube assembly. The maximum outer diameter of the helical purifier tube assembly is defined as the diameter of a cylinder into which the helical purifier tube assembly will fit wherein the cylinder axis and the helical purifier tube assembly axis are generally parallel or congruent. The outer diameter of the helical purifier tube assembly at any axial location may be equal to or less than the maximum outer diameter. The geometric parameters of pitch, angle, and outer diameter may be constant over the axis or length of the helical purifier tube assembly; alternatively, any of these parameters may vary over the axis or length of the helical purifier tube assembly. Thus the axis of the tubing in the helical purifier tube assembly may form an exact helix according to the above definition or may form a generally helical shape in which any of the characterizing parameters vary along the axis or length of the assembly.

The helical purifier tube assembly should be constructed of a material sufficiently strong and relatively stiff to retain its shape and support its weight at the attachment point to the cylinder valve, and should be compatible with the fluid in the cylinder and the purification material in the helical purifier tube assembly. Some flexibility of the material, however, may be desirable. The helical purifier tube assembly may be constructed of stainless steel, preferably from an austenitic stainless steel such as AISI316. Alternatively, carbon steel, low alloy steel, copper, copper alloys, nickel, nickel alloys (such as Hastelloy® C22 and the like), cupronickel alloys, and other similar metallic alloys may be preferred in certain applications. Nonmetallic materials such as engineering polymers (for example, polyvinylidenedifluoride (Kynar™)), glass, and ceramic materials could be practical in certain selected applications.

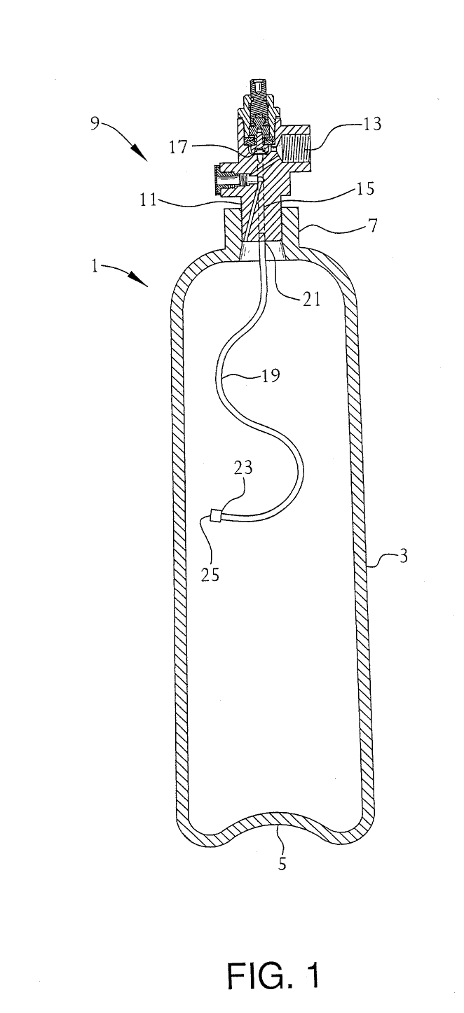

A first exemplary embodiment of the invention is shown in FIG. 1, which is for illustration purposes only and is not necessarily to scale. Cylinder 1 comprises wall section 3, closed bottom 5, and internally-threaded cylindrical neck 7. Valve assembly or valve body 9 (described later) comprises externally-threaded inlet section 11 and product outlet port 13. Externally-threaded valve inlet section 11 can be threadedly inserted and sealably connected to internally-threaded cylindrical neck 7 as shown, and can be unscrewed or disassembled as required to remove valve assembly or valve body 9 from cylinder 1. Alternatively, externally-threaded valve inlet section 11 may be connected to internally-threaded cylindrical neck 7 by an connector or bull plug (not shown) which has internal threads sealably connected with threaded valve inlet section 11 and external threads sealably connected to internally-threaded cylindrical neck 7. The bull plug and the internally-threaded cylindrical neck 7 can be unscrewed or disassembled as required to remove valve assembly 9 from cylinder 1. An internal bore in the bull plug allows fluid communication between the interior of cylinder 3 and valve assembly or valve body 9. In either of these alternatives, whether or not the bull plug is used, valve assembly or valve body 9 can be sealably connected to and disconnected from cylindrical neck 7.

Externally-threaded valve inlet section 11 has internal bore 15 which connects the interior of cylinder 1 to valve seat 17. Helical purifier tube assembly 19 is connected at first end 21 to the internal port of valve internal bore 15. Alternatively, if a bull plug is used as described above, first end 21 may be connected to the bore in the bull plug to allow fluid communication between the interior of cylinder 3 and valve internal bore 15.

One or more purification materials capable of selectively removing impurities from the fluid contained in cylinder 1 are disposed inside the helical purifier tube assembly 19, that is, the materials are contained within the tubing which forms the assembly. The term “inside the helical purifier tube assembly” means the internal volume of the tubing or pipe which forms the helical purifier tube assembly. First end 21 of helical purifier tube assembly 19 may include means (not shown) such as a screen and/or sintered metal element to retain the purification materials inside of helical purifier tube assembly 19. The other end 23 of helical purifier tube assembly 19 also may include means such as a screen and/or sintered metal element to retain the purification materials inside of helical purifier tube assembly 19. For example, filter element 25 may be attached to end 23 to retain the purification materials inside of helical purifier tube assembly and also to remove residual particulate matter from the fluid during withdrawal. Helical purifier tube assembly 19 may be fabricated from a length of conduit or tubing which can be readily shaped into the preferred helical configuration.

At least a portion of the internal volume of the tube which forms helical purifier tube assembly 19 is filled, preferably before installation into the vessel, with an appropriate purification material or medium. The selection of the material will depend on the nature of the impurities to be removed from the fluid and on the properties of the fluid being purified. Various adsorbents, absorbents, catalysts and getters which are well known in the art may be used. Examples include but are not limited to zeolite molecular sieves (e.g. aluminosilicate molecular sieves type 13X, 3A, 4A, 5A, Y, mordenite, chabazite, ZSM-5, all of which may be prepared with various Si/Al ratios), activated carbons, alumina, macroreticular polymers, supported liquid absorbents, and supported metal getters (e.g. copper on alumina, nickel on silica/alumina, cesium on carbon). Typically, the purification medium will be in the form of a packed bed of pellets, extrudates, spheres, particles, fibers or irregular chunks. Structured purification materials, such as coated or extruded honeycomb monoliths, rolled corrugated sheets, and the like may also be employed. In one embodiment, a liquid could be used as a purification medium, though in this application, the liquid could not completely fill the internal volume of the vessel. Suitable liquid solvents could include, for example, sulfuric acid, ionic liquids, and halocarbon oils.

The fluid in cylinder 1 may be a gas above its critical temperature such as nitrogen, argon, helium, hydrogen, a noble gas, or a gas mixture. Alternatively, the fluid in cylinder 1 may be a compressed liquefied gas comprising coexisting vapor and liquid phases. Typical compressed liquefied gases may include, for example, ammonia, chlorine, hydrogen chloride, hydrogen bromide, trichlorosilane, silicon tetrachloride, and methyltrichlorosilane. When the cylinder is oriented vertically or nearly vertically, the liquid level should be below end 23 to ensure that only vapor flows into helical purifier tube assembly 19. When the cylinder is oriented horizontally or nearly horizontally, the level liquid level likewise should be below end 23 to ensure that only vapor flows into helical purifier tube assembly 19.

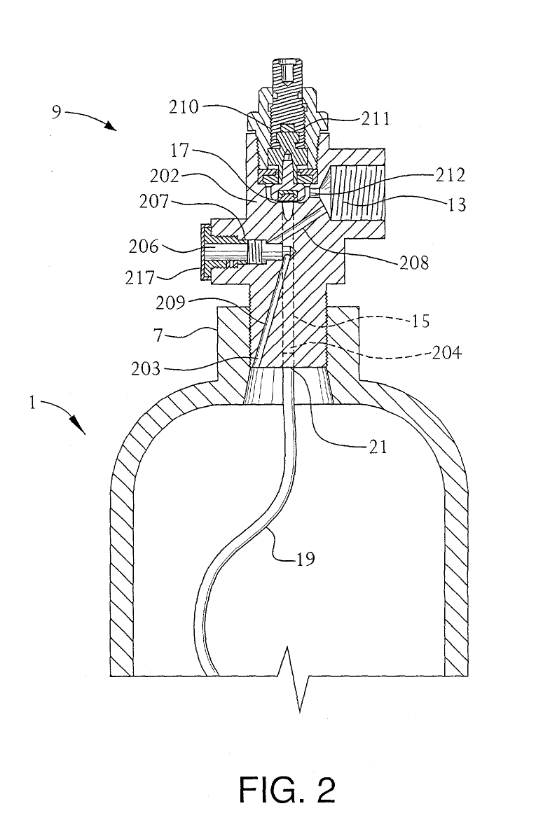

An enlarged view of valve assembly 9 is shown in FIG. 2, which is for illustration purposes only and is not necessarily to scale. This valve is representative of any of the numerous types of valves known in the art for cylinder valve service. The valve comprises body 202 having first internal port 203, second internal port 204 connected to end 21 of helical purifier tube assembly 19, and product outlet port 13. Filing valve member 206 is threadedly mounted in bore 207 and, in the position shown, prevents fluid flow between product outlet port 13 and first internal port 203 via a passageway formed by bore 208 and bore 209. Discharge valve member 210 is threadedly mounted in bore 211 and, in the position shown, seals valve seat 17 to prevent fluid flow between second internal port 204 and product outlet port 13 via bore 15 and bore 212. Valve assembly 9 typically may have a pressure relief valve (not shown) to relieve accidental overpressuring of the cylinder.

A typical procedure for initial preparation of cylinder 1 and valve assembly 9 for service is illustrated by the following example. The internal volume of the tube which forms helical purifier tube assembly 19 is filled partially or completely with the desired purification material and end 21 is connected to port 204 of valve assembly 9. Cylinder 1 may be cleaned by standard methods and readied for filling. The combined valve assembly 9, helical purifier tube assembly 19, and the purification material contained therein forms a combined valve and purifier tube assembly, which also may be defined as a fluid flow control and fluid purification assembly. The term “filling at least a portion of the helical purifier tube assembly” as used herein means that the purification material is introduced into the internal volume of the tube which forms the helical purifier tube assembly.

The combined valve and purifier tube assembly is manipulated to insert end 23 (FIG. 1) of helical purifier tube assembly 19 into the internal bore of internally-threaded cylindrical neck 7. The combined valve and helical purifier tube assembly is rotated as helical purifier tube assembly 19 is inserted through neck 7 and into the interior of cylinder 1. Externally-threaded valve inlet section 11 is screwed into and sealed to internally-threaded cylindrical neck 7. The assembled cylinder is then evacuated and optionally heated or otherwise prepared for filling. Discharge valve member 210 is seated against valve seat 17 to isolate bore 212 from bore 15.

A fill line (not shown) is connected to product outlet port 13, filling valve member 206 is screwed slightly outward in bore 207 to place bore 208 and bore 209 in fluid flow communication, and product fluid is charged into cylinder 1 to the desired level. Filling valve member 206 is screwed inward in bore 207 to terminate fluid flow communication between bore 208 and bore 209. The fill line (not shown) is disconnected from product outlet port 13. Filled cylinder 1 may be prepared for transportation and may be transported to a consumer's site. To deliver high-purity gas or vapor product to the consumer, a product delivery line (not shown) is connected to product outlet port 13 and prepared for service. Typically the product delivery line is repeatedly evacuated and purged with feed gas, although either evacuation or purge alone may be used.

Purified product is supplied by backing valve member 210 away from valve seat 17 to open the valve and place bore 212 in fluid flow communication with bore 15. Product fluid in cylinder 1 flows through optional filter 25 (FIG. 1), end 23, helical purifier tube assembly 19 wherein impurities are removed. Purified gas flows through valve assembly 9 to outlet port 13 and through a connected product line (not shown) to supply high-purity gas product to the consumer. The term “withdrawing fluid through the helical purifier tube assembly” as used herein means that the withdrawn fluid flows through the internal volume of the tube which forms the helical purifier tube assembly.

When cylinder 1 is empty, refilling may be accomplished as described above for the initial filling procedure. After a predetermined number of fill/product delivery cycles, the purification material will become spent and replacement will be required. To effect replacement, valve assembly 9 with attached helical purifier vessel is unscrewed from cylindrical neck 7, spent purification material may be removed from the tube which forms helical purifier tube assembly 19 and fresh purification material placed in the tube. Alternatively, spent purification material in helical purifier tube assembly 19 may be regenerated in place by various combinations of heating and purging. As described earlier, the combined valve and purifier vessel assembly is manipulated to insert end 23 (FIG. 1) of helical purifier tube assembly 19 into the internal bore of internally-threaded cylindrical neck 7. The combined valve and purifier vessel assembly is rotated as helical purifier tube assembly 19 is inserted through neck 7 and into the interior of cylinder 1. Externally-threaded valve inlet section 11 is screwed into and sealed to internally-threaded cylindrical neck 7. Cylinder fill and high-purity product supply may proceed as described above.

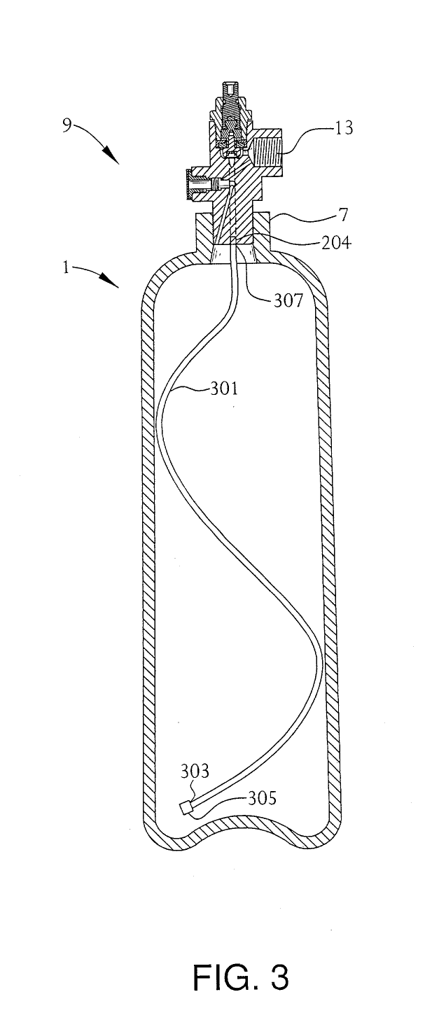

An alternative exemplary embodiment of the invention is shown in FIG. 3, which is for illustration purposes only and is not necessarily to scale. Cylinder 1 and valve assembly 9 may be the same as described earlier with respect to FIGS. 1 and 2, and the initial assembly, initial fill, subsequent fills, and replacement of the purification material is similar to that described above. In this alternative embodiment, helical purifier tube assembly 301 has a longer pitch and may reach to the end of cylinder 1 as shown. First end 303 of helical purifier tube assembly 301 may include means (not shown) such as a screen and/or sintered metal element to retain the purification materials inside of helical purifier tube assembly 19. The other end 307 of helical purifier tube assembly 301 also may include means such as a screen and/or sintered metal element to retain the purification materials inside of helical purifier tube assembly 301. End 303 may be attached to filter 305 similar to that described in FIG. 1.

When the pitch of helical purifier tube assembly 301 is selected properly relative to the inner diameter of cylindrical neck 7, the helical purifier tube assembly may reach the inner wall of cylinder 1 as shown. When the cylinder is oriented vertically, it may be charged with high pressure gas which is withdrawn through helical purifier tube assembly 301. When the cylinder is oriented horizontally, with end 303 preferably oriented upward, the cylinder may be charged with a compressed liquefied gas such that the liquid level is below tube end 303. Vapor from the head space is withdrawn through helical purifier tube assembly 301 to contact purification material contained therein. Purified gas flows through valve assembly 9 to outlet port 13 and through a connected product line (not shown) to supply high-purity gas product to the consumer. In this horizontal orientation, helical purifier tube assembly 301 may rest on the bottom wall of the cylinder, thereby relieving stress where upper tube end 307 is joined to internal port 204 of valve assembly 9.

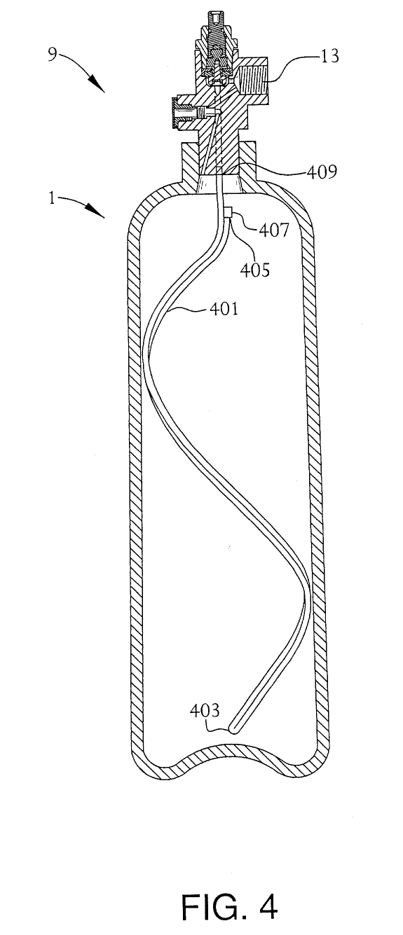

Another exemplary embodiment of the invention is shown in FIG. 4, which is for illustration purposes only and is not necessarily to scale. Cylinder 1 and valve assembly 9 may be the same as described above with respect to FIGS. 1 to 3, and the initial assembly, initial fill, subsequent fills, and replacement of the purification material is similar to that described above. In this embodiment, helical purifier tube assembly 401 is made of two helical tubes having essentially the same pitch and diameter which are joined at bottom end 403 and are adjacent along their common length. These tubes may be brazed together to form an integrated double-tubed helical purifier tube assembly as shown.

First end 409 of helical purifier tube assembly 401 may include means (not shown) such as a screen and/or sintered metal element to retain the purification materials inside of helical purifier tube assembly 401. The other end 405 of helical purifier tube assembly 401 also may include means such as a screen and/or sintered metal element to retain the purification materials inside of helical purifier tube assembly 301. End 405 may be attached to filter 407 similar to that described in FIG. 1. Upper tube end 405 of the tube may be attached to filter 407 similar to that described in FIGS. 1 and 3. Purification material as described above is contained in the tubes of helical purifier tube assembly 401.

In this embodiment, the cylinder preferably is used in a vertical position, and most advantageously is used to contain a compressed liquefied gas wherein the liquid surface is maintained below upper tube end 405. This allows the utilization of almost the entire volume of the cylinder for the initial liquid charge. Vapor from the head space is withdrawn through optional filter 407 and tube end 405, and is purified while flowing downward through the first tube section and upward through the second tube section. Purified gas flows through valve assembly 9 to outlet port 13 and through a connected product line (not shown) to supply high-purity gas product to the consumer.

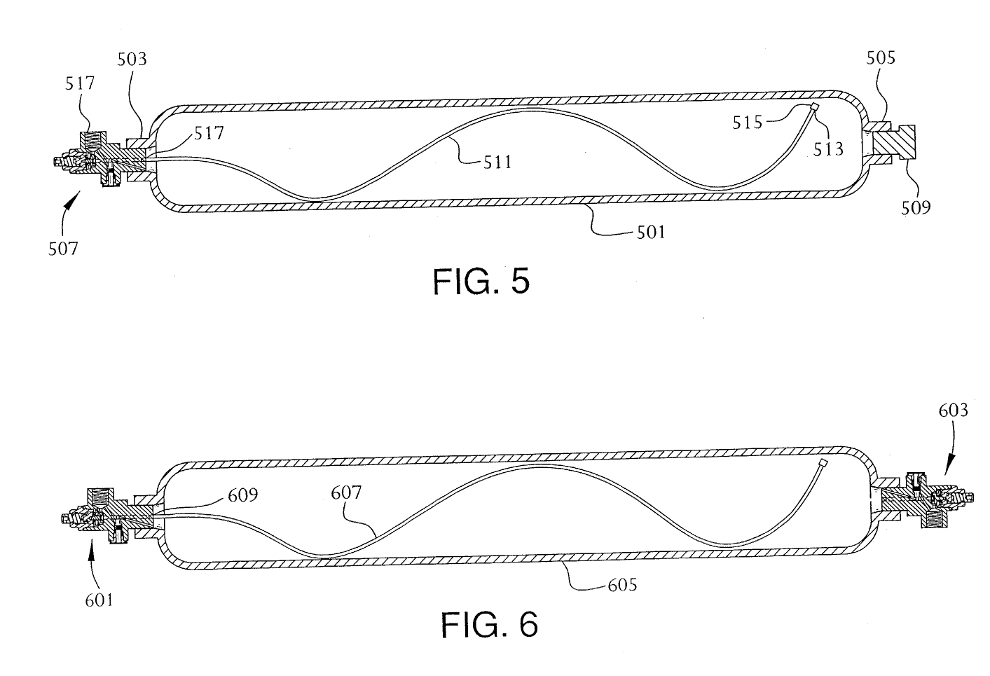

Compressed gas cylinders often are designed for service in a horizontal orientation and typically have larger capacities than cylinders designed for vertical service. These cylinders may be fabricated with threaded cylindrical necks at either end. The helical purifier tube assembly can be used with these horizontal cylinders as illustrated in FIGS. 5 and 6, which are for illustration purposes and are not necessarily to scale. Referring to FIG. 5, cylinder 501 is fitted with cylindrical necks 503 and 505. In this embodiment, valve assembly 507, which is similar to fill valve assembly 9 in FIGS. 1-4, is threaded into cylindrical neck 503. Opposite cylindrical neck 505 may be sealed with plug 509. Helical purifier tube assembly 511 is similar to the helical purifier tube assemblies described above with reference to FIGS. 1-4, contains similar purification material, and end 513 may have optional filter 515. The initial assembly, initial fill, subsequent fills, and replacement of the purification material in the embodiment of FIG. 5 is similar to that described above with reference to FIGS. 1-3. Insertion of helical purifier tube assembly 511 may be facilitated by pulling end 513 of the tube using a rod or wire inserted through cylindrical neck 505 while pushing and rotating the tube through cylindrical neck 503. The opening in cylindrical neck 505 also may be used for inspection and cylinder cleaning purposes between fills.

In this horizontal orientation, helical purifier tube assembly 511 may be designed to rest on the bottom wall of cylinder 501, thereby relieving stress where upper tube end 517 is joined to valve assembly 507. In this embodiment, cylinder 501 can be used most advantageously to contain a compressed liquefied gas wherein the liquid surface is maintained below upper tube end 513. This allows the utilization of almost the entire volume of the cylinder for the initial liquid charge. Vapor from the head space is withdrawn through optional filter 515 and tube end 513, and is purified while flowing through helical purifier tube assembly 511. Purified gas flows through valve assembly 507 to outlet port 517 and through a connected product line (not shown) to supply high-purity gas product to the consumer.

An alternative to the embodiment of FIG. 5 is illustrated in FIG. 6. In this embodiment, valve assemblies 601 and 603 are installed in the respective ends of cylinder 605. Helical purifier tube assembly 607 is similar to helical purifier tube assembly 511 of FIG. 5 and is connected at end 609 to the inlet port of valve assembly 601. Valve assemblies 601 and 603 may be typical cylinder shutoff valves without the fill feature described above with reference to valve assembly 9 of FIG. 2. In the embodiment of FIG. 6, valve assembly 603 is used for filling cylinder 605 and valve assembly 601 is used for purified product gas withdrawal. The embodiment of FIG. 6 is similar to the embodiment of FIG. 5 regarding initial assembly and replacement of purification material in helical purifier tube assembly 607.

When any of the embodiments described above is used with a compressed liquefied gas, the opening of the helical purifier tube assembly containing purification material preferably is located near the top of the vessel in order to withdraw vapor from the vessel head space. It may be desirable in this application to prevent liquid from entering the helical purifier tube assembly, because liquid may collect at low points in the tube below the liquid level in the vessel where the hydrostatic pressure is greater than the saturated vapor at the top of the vessel. Liquid in contact with the purification material may damage the stability or the performance of the material. To minimize this problem, a check valve may be installed the vapor inlet end of the tube to prevent inflow of liquid. The cracking pressure of the check valve should be sufficient to overcome varying liquid hydrostatic pressure caused by changes in vessel and liquid orientation during transport, and also to prevent condensation of the saturated vapor caused by capillary forces in the purification material by the hydrostatic pressure in the submerged section of the tube.

The helical purifier tube assembly described in the above embodiments may have a constant pitch and outer diameter over its entire length, or alternatively may have a variable pitch and/or variable outer diameter over its length. In all embodiments, the maximum outer diameter of the helical purifier tube assembly is greater than the inside diameter of the cylindrical neck through which it is inserted into the interior of the cylinder. The geometric characteristics of a helical purifier tube assembly which can be inserted into a cylinder are determined by a number of variables which include the inside diameter and length of the cylindrical neck, the inside diameter of the cylinder, and the outside diameter of the tubing used for the helical purifier tube assembly. In one embodiment, a constant or essentially constant pitch and helix angle may be selected so that insertion of the helical purifier tube assembly through the cylindrical neck is accomplished by rotating the helical tube during insertion about an axis which is essentially parallel to the cylinder axis. In this embodiment, the outer diameter of the helical purifier tube assembly may approach the inner diameter of the cylinder as illustrated by the Example below.

Alternatively, a smaller pitch may be used for the initial length of the helical purifier tube assembly and a longer pitch for the remaining length. In this alternative, the axis of the helical purifier tube assembly initially may be at an angle to the cylinder axis, and the axis of the helical purifier tube assembly may precess about the cylinder axis as the initial section of the helical tube is rotated and inserted through the cylindrical neck. When the section of inserted helical purifier tube assembly approaches the internal cylinder wall, the remaining length of the helical purifier tube assembly should have a longer pitch to allow further insertion of the tube into the cylinder. Thus in this embodiment the helical purifier tube assembly will have an initial section of a given pitch and a remaining section having a longer pitch, and the section having a longer pitch also may have a smaller diameter if desired. Any workable combination of helix pitches, diameters, and/or angles may be used for the helical purifier tube assembly.

### EXAMPLE

A gas storage cylinder is selected having an inside diameter of 22 inches with an internally-threaded cylindrical neck having an inside diameter of 2.5 inches and a length of 3 inches. A length of tubing with an outside diameter of 0.5 inches is formed into a helical purifier tube assembly having a pitch of 36 inches and a helix angle of 57.5 degrees. The outside diameter of the helix formed by the helical purifier tube assembly is slightly less than 22 inches. The internal volume of the tube which forms the helical purifier tube assembly is filled with a purification material described earlier. A first end of the helical purifier tube assembly is attached to the inlet port of a cylinder valve having an externally-threaded member as illustrated in FIG. 3. The second end of the helical purifier tube assembly is inserted into the cylindrical neck and the helical purifier tube assembly is rotated about its axis as the tube is inserted through the neck and into the cylinder. The valve is threaded into the internally-threaded cylinder neck to complete the installation of the helical purifier tube assembly. The outside diameter of the helical purifier tube assembly lies closely adjacent to the inner wall of the cylinder.

The present invention thus relates to a modified purifier tube for use as a built-in purifier for the delivery of high purity gases from a gas cylinder. The purifier tube is configured in a helical shape and is installed inside of a gas cylinder, wherein the helical purifier tube assembly provides a longer effective length than a straight tube having the same length as the helical purifier tube assembly. This allows the use of a larger amount of purification material in a helical tube of a given helix length compared to a straight tube of the same length. Conversely, the invention allows the use of the same amount of purification material in a purifier having a shorter length than that required for a straight tube.

1. A fluid storage and purification system which comprises:
(a) a cylindrical vessel having an exterior and an interior containing a fluid, the vessel having a first end and a second end, wherein the first end has a cylindrical neck, and wherein the inside diameter of the cylindrical neck is smaller than the inside diameter of the vessel;
(b) a helical purifier tube assembly which is disposed in the interior of the vessel, wherein the maximum outer diameter of the helical purifier tube assembly is larger than the inside diameter of the cylindrical neck, wherein the tube has a first end and a second end, and wherein the first end is in fluid flow communication with the interior of the vessel;
(c) one or more materials disposed inside the helical purifier tube assembly, which materials are capable of selectively removing impurities from the fluid; and
(d) a valve comprising a body, an inlet, and an outlet, wherein the valve body can be sealably connected to and disconnected from the cylindrical neck and wherein the second end of the helical purifier tube assembly is connected to the inlet of the valve, whereby the fluid in the interior of the vessel can be withdrawn through the helical purifier tube assembly and delivered through the outlet of the valve to the exterior of the vessel.

2. The system of claim 1 wherein the one or more materials disposed inside the helical purifier tube assembly are granular materials selected from the group consisting of adsorbent materials, absorbent materials, catalytic materials, getter materials, and filtration materials, wherein the materials are capable of selectively removing impurities from the fluid.

3. The system of claim 2 wherein the fluid is a gas.

4. The system of claim 2 wherein the fluid comprises coexisting liquid and vapor phases and wherein the helical purifier tube assembly is oriented in the cylinder such that vapor can be withdrawn through the tube.

5. The system of claim 2 wherein the cylinder is oriented vertically.

6. The system of claim 2 wherein the cylinder is oriented horizontally.

7. The system of claim 6 wherein the cylinder has an additional cylindrical neck disposed at the second end.

8. The system of claim 7 which further comprises another valve comprising a body, an inlet, and an outlet, wherein the valve body can be sealably connected to and disconnected from the additional cylindrical neck.

9. A method of supplying a purified fluid product which comprises:
(a) providing a cylindrical vessel having an exterior and an interior, wherein the vessel is closed at one end and fitted with a cylindrical neck at the other end, wherein the inside diameter of the cylindrical neck is smaller than the inside diameter of the vessel, and wherein fluid containing one or more impurities is disposed in the interior of the vessel;
(b) providing a helical purifier tube assembly which is disposed in the interior of the vessel, wherein the maximum outer diameter of the helical purifier tube assembly is larger than the inside diameter of the cylindrical neck, wherein the helical purifier tube assembly has a first end and a second end, and wherein the first end is in fluid flow communication with the interior of the vessel;
(c) providing one or more granular materials disposed inside the helical purifier tube assembly and selected from the group consisting of adsorbent materials, absorbent materials, catalytic materials, getter materials, and filtration materials, wherein the materials are capable of selectively removing impurities from the fluid;
(d) providing a valve comprising a body, an inlet, and an outlet, wherein the valve body can be sealably connected to and disconnected from the cylindrical neck, and wherein the second end of the helical purifier tube assembly is connected to the inlet of the valve, whereby the fluid in the interior of the vessel can be withdrawn through the helical purifier tube assembly and delivered through the outlet of the valve to the exterior of the vessel; and
(e) withdrawing fluid from the interior of the vessel through the helical purifier tube assembly, contacting the fluid with the one or more granular materials disposed therein to yield a purified fluid product, and withdrawing the purified fluid product through the valve to the exterior of the vessel.

10. The method of claim 9 wherein the fluid is a gas.

11. The method of claim 9 wherein the fluid comprises coexisting liquid and vapor phases and wherein the helical purifier tube assembly is oriented in the cylinder such that vapor can be withdrawn through the tube.

12. The method of claim 9 wherein the cylinder is oriented vertically.

13. The system of claim 9 wherein the cylinder is oriented horizontally

14. A method of making a fluid storage and purification system which comprises:
(a) providing a cylindrical vessel having an exterior and an interior, the vessel having a first end and a second end, wherein the first end has a cylindrical neck, and wherein the inside diameter of the cylindrical neck is smaller than the inside diameter of the vessel;
(b) providing a helical purifier tube assembly, wherein the maximum outer diameter of the helical purifier tube assembly is larger than the inside diameter of the cylindrical neck, wherein the helical purifier tube assembly has a first end and a second end, and filling at least a portion of the helical purifier tube assembly with one or more materials selected from the group consisting of adsorbent materials, absorbent materials, catalytic materials, getter materials, and filtration materials, wherein the materials are capable of selectively removing impurities from the fluid;
(c) providing a valve comprising a body, an inlet, and an outlet, wherein the valve body can be sealably connected to and disconnected from the cylindrical neck, and sealably connecting the second end of the helical purifier tube assembly to the inlet of the valve to provide a valve and tubing assembly;
(d) inserting the first end of the helical purifier tube assembly into the cylindrical neck, rotating the valve and tubing assembly while inserting the helical purifier tube assembly through the neck and into the interior of the vessel; and
(e) sealably connecting the valve to the cylindrical neck.

15. A fluid flow control and fluid purification assembly which comprises:
(a) a helical purifier tube assembly having a first end and a second end, wherein the first end is in flow communication with a fluid;
(b) one or more purification materials disposed inside the helical purifier tube assembly, which materials are capable of selectively removing impurities from the fluid; and
(c) a valve comprising a body, an inlet, and an outlet, wherein the second end of the helical purifier tube assembly is sealably connected to the inlet of the valve, whereby the fluid can be withdrawn through the helical purifier tube assembly and delivered through the outlet of the valve.

16. The assembly of claim 15 wherein the one or more materials disposed inside the helical purifier tube assembly are granular materials selected from the group consisting of adsorbent materials, absorbent materials, catalytic materials, getter materials, and filtration materials.
